(19) United States
(12) Patent Application Publication
(10) Pub. No.: US 2026/0202523 A1
(43) Pub. Date: Jul. 16, 2026

(54) DEVICE AND METHOD FOR CALIBRATION OF LIDAR DEVICE

(71) Applicant: LG INNOTEK CO., LTD., Seoul (KR)

(72) Inventors: Heehoon JUNG, Seoul (KR); Jaeshin HAN, Seoul (KR)

(73) Assignee: LG INNOTEK CO., LTD., Seoul (KR)

(21) Appl. No.: 19/444,503

(22) Filed: Jan. 9, 2026

(30) Foreign Application Priority Data
Jan. 13, 2025 (KR) 10-2025-0004618

(51) Int. Cl. G01S 7/497; G01S 7/481; G06T 7/80

(52) U.S. Cl. CPC G01S 7/497; G01S 7/4816; G01S 17/02; G06T 7/80; G06T 2200/04; G06T 2207/10028; G06T 2207/20048

(57) ABSTRACT

The present invention provides a calibration device for a LiDAR (Light Detection and Ranging) device, the calibration device comprising: a azimuthal rotation adjusting unit configured to rotate a device under test (DUT) in a azimuthal direction; a elevational rotation adjusting unit configured to rotate the DUT in a elevational direction; and a processing unit configured to control operations of the DUT, the azimuthal rotation adjusting unit, and the elevational rotation adjusting unit, and to perform calibration on the DUT based on information output from the DUT, the azimuthal rotation adjusting unit, and the elevational rotation adjusting unit.

### TECHNICAL FIELD

The present invention relates to a calibration device and a calibration method for a LIDAR (Light Detection and Ranging) device.

More specifically, the present invention relates to a device and a method for computing geometric offsets and/or distance offsets for the LIDAR device and applying the computed offsets to the LIDAR device.

### BACKGROUND

A LIDAR (Light Detection And Ranging) system including a LIDAR sensor may include a plurality of modules. Each of the modules may be assembled with one another to constitute an entire LIDAR system.

Meanwhile, during a manufacturing process of each of the plurality of modules, a predetermined process error and/or component error may occur. Alternatively, during a process of combining the plurality of modules to construct the entire LIDAR system, a process error and/or component error may occur.

By such process errors and component errors, the performance of a LIDAR system may fail to meet predetermined reference performance metrics required in autonomous driving technologies. For example, the reference performance metrics may include at least one selected from the group consisting of per-pixel/per-channel distance accuracy of a LIDAR sensor, reflectivity, and a field of view (FOV).

The use of LIDAR sensors is increasing across various fields. In particular, the importance of LIDAR sensors is emerging in the field of autonomous driving.

Accordingly, in order to satisfy performance metrics required in autonomous driving technologies, there is a need for a procedure of verifying whether a LIDAR system, in which coupling among a plurality of modules has been completed, satisfies the reference performance metrics before shipment. In addition, when the performance of the LIDAR system fails to satisfy the reference performance metrics, there is a need for a device and a method for providing a geometric offset and/or a range offset suitable for the LIDAR system.

### SUMMARY

### Technical Problem

An object of the present invention is to provide a calibration device and a calibration method for computing geometric offsets and/or range offsets for a LIDAR device and applying the computed offsets to the LIDAR device.

### Technical Solution

To achieve the above object of the present invention, there is provided a calibration device for a LIDAR (Light Detection And Ranging) device, the calibration device comprising:
a azimuthal rotation adjusting unit configured to rotate a device under test (DUT) in a azimuthal direction;
a elevational rotation adjusting unit configured to rotate the DUT in a elevational direction; and
a processing unit configured to control operations of the DUT, the azimuthal rotation adjusting unit, and the elevational rotation adjusting unit, and to perform calibration for the DUT based on information output by the DUT, the azimuthal rotation adjusting unit, and the elevational rotation adjusting unit.

According to an embodiment of the present invention, the processing unit may be configured to: control the DUT to record a single frame; control the DUT to generate an initial GmAPD (Geiger-mode Avalanche PhotoDiode)-based image based on the frame; apply test offsets to the DUT over N steps and generate a GmAPD-based image based on each of the test offsets over the N steps; and determine a azimuthal direction offset of the DUT based on the GmAPD-based image.

According to an embodiment of the present invention, the step of controlling the DUT to record the single frame may include: controlling the azimuthal rotation adjusting unit to rotate the DUT by a single rotation; and controlling the DUT to record the single frame during the single rotation.

According to an embodiment of the present invention, the step of determining the azimuthal direction offset of the DUT based on the GmAPD-based image may include: calculating a pixel-wise structured similarity cost between each of the GmAPD-based images and a reference image; and calculating, based on the structured similarity cost, a least square cost value of each of the GmAPD-based images with respect to the reference image.

According to an embodiment of the present invention, the step of determining the azimuthal direction offset of the DUT based on the GmAPD-based image may further include determining, among the test offsets over the N steps, a test offset that minimizes the least square cost value as the azimuthal direction offset of the DUT.

According to an embodiment of the present invention, the processing unit may be configured to: control the DUT to record a frame and compute a point cloud based on the frame; acquire reference data corresponding to the computed point cloud; perform at least one of down sampling and filtering on each of the point cloud and the reference data; compute an initial transformation matrix between the point cloud and the reference data and apply the initial transformation matrix to the DUT; and compute an optimal transformation matrix for the DUT based on a G-ICP (Generalized Iterative Closest Point) algorithm.

According to an embodiment of the present invention, when the transformation matrix is applied to the DUT, the transformation matrix may be configured to correct errors related to laser skew, azimuthal direction errors, and elevational direction FOV offsets of the DUT.

According to an embodiment of the present invention, the processing unit may be configured to: control the DUT to perform scanning of a plurality of fiducial marks and record a frame based on the scanning; control the DUT to generate a GmAPD (Geiger-mode Avalanche PhotoDiode)-based image including pixels corresponding to each of the fiducial marks based on the frame; identify three-dimensional coordinate data for a center of each of the fiducial marks from the GmAPD-based image; perform line fitting among the centers of the fiducial marks based on the identified three-dimensional coordinate data; and compute a laser skew angle of the DUT based on the line fitting.

According to an embodiment of the present invention, the step of controlling the DUT to perform scanning of a plurality of fiducial marks and record the frame based on the scanning may include: controlling the azimuthal rotation adjusting unit to rotate the DUT in a azimuthal direction by a defined angle; and controlling the DUT to perform the scanning of the fiducial marks while rotating by the defined angle.

According to an embodiment of the present invention, the fiducial marks may be arranged to be spaced apart from each of the DUT and the calibration device by a same distance.

According to an embodiment of the present invention, one of the fiducial marks may be arranged to be located at one end of a azimuthal direction FOV of the DUT when the DUT starts azimuthal rotation, and the other of the fiducial marks may be arranged to be located at the other end of the azimuthal direction FOV of the DUT when the DUT ends the azimuthal rotation.

According to an embodiment of the present invention, the processing unit may be configured to: control the elevational rotation adjusting unit to rotate the DUT in a elevational direction in N rotation steps; control the DUT to perform scanning with respect to at least one of the fiducial marks at each of the N rotation steps and record a frame based on the scanning; control the DUT to generate a GmAPD-based image based on the frame; and compute an azimuthal direction error of the DUT based on the GmAPD-based image.

According to an embodiment of the present invention, the GmAPD-based image may include a pixel corresponding to the fiducial mark.

According to an embodiment of the present invention, the step of computing the azimuthal direction error of the DUT based on the GmAPD-based image may include: identifying azimuthal direction coordinate data with respect to a center of the fiducial mark from the GmAPD-based image; calculating a deviation value between the azimuthal direction coordinate data and reference data for the azimuthal direction coordinate data; and computing the azimuthal direction error of the DUT based on the deviation value.

According to an embodiment of the present invention, the processing unit may be configured to: control the azimuthal rotation adjusting unit to rotate the DUT in a elevational direction in N rotation steps; control the DUT to perform scanning with respect to at least one of the fiducial marks at each of the N rotation steps and record a frame based on the scanning; control the DUT to generate a GmAPD (Geiger-mode Avalanche PhotoDiode)-based image based on the frame; and compute an elevational direction FOV offset of the DUT based on the GmAPD-based image.

According to an embodiment of the present invention, the GmAPD-based image may include a pixel corresponding to the fiducial mark.

According to an embodiment of the present invention, the step of computing the elevational direction FOV offset of the DUT based on the GmAPD-based image may include: identifying elevational direction coordinate data with respect to a center of the fiducial mark from the GmAPAPD-based image; calculating a deviation value between the elevational direction coordinate data and reference data for the elevational direction coordinate data; and computing the elevational direction FOV offset of the DUT based on the deviation value.

According to an embodiment of the present invention, the processing unit may be configured to: control the DUT to perform scanning of at least one target and record a plurality of frames based on the scanning; control the DUT to generate a GmAPD (Geiger-mode Avalanche PhotoDiode)-based image including a pixel corresponding to the target based on the frame; identify pixels of the GmAPD-based image corresponding to the target on the GmAPD-based image; select at least some of the identified pixels; compute an evaluation value for the selected pixels; compute an evaluation result for the evaluation value based on a defined criterion; and adjust parameters for each of a plurality of pixels included in the DUT based on the evaluation result.

According to an embodiment of the present invention, when the at least one target comprises a plurality of targets, the plurality of targets may be configured such that at least one of reflectivity and distance is different from one another.

According to an embodiment of the present invention, the step of identifying pixels of the GmAPD-based image corresponding to the target on the GmAPD-based image may include: identifying azimuthal direction coordinate data and elevational direction coordinate data included in each of the pixels of the GmAPD-based image corresponding to the target; and identifying a minimum value and a maximum value with respect to each of the azimuthal direction coordinate data and the elevational direction coordinate data.

According to an embodiment of the present invention, the step of selecting at least some of the identified pixels may be performed based on the minimum value and the maximum value with respect to each of the azimuthal direction coordinate data and the elevational direction coordinate data.

According to an embodiment of the present invention, the evaluation value may be at least one selected from the group consisting of a true positive rate and a false positive rate for distance information calculated by the DUT, an average and a standard deviation of distance bias, and an average of signal intensity.

According to an embodiment of the present invention, the evaluation result may be output depending on whether the evaluation value falls within a defined numerical range.

To achieve the above object of the present invention, there is provided a calibration method for a LIDAR device using a calibration device, the method comprising: controlling the DUT to record a single frame; controlling the DUT to generate an initial GmAPD (Geiger-mode Avalanche PhotoDiode)-based image based on the frame; applying test offsets to the DUT over N steps and generating a GmAPD-based image based on each of the test offsets over the N steps; and determining a azimuthal direction offset of the DUT based on the GmAPD-based image.

According to an embodiment of the present invention, the step of controlling the DUT to record the single frame may include: controlling a azimuthal rotation adjusting unit included in the calibration device to rotate the DUT by a single rotation; and controlling the DUT to record the single frame during the single rotation.

According to an embodiment of the present invention, the step of determining the azimuthal direction offset of the DUT based on the GmAPD-based image may include: calculating a pixel-wise structured similarity cost between each of the GmAPD-based images and a reference image; and calculating, based on the structured similarity cost, a least square cost value of each of the GmAPD-based images with respect to the reference image.

According to an embodiment of the present invention, the step of determining the azimuthal direction offset of the DUT based on the GmAPD-based image may further include determining, among the test offsets over the N steps, a test offset that minimizes the least square cost value as the azimuthal direction offset of the DUT.

To achieve the above object of the present invention, there is provided a calibration method for a LIDAR device using a calibration device, the method comprising: controlling the DUT to record a frame and compute a point cloud based on the frame; acquiring reference data corresponding to the computed point cloud; performing at least one of down sampling and filtering on each of the point cloud and the reference data; computing an initial transformation matrix between the point cloud and the reference data and applying the initial transformation matrix to the DUT; and computing an optimal transformation matrix for the DUT based on a G-ICP (Generalized Iterative Closest Point) algorithm.

According to an embodiment of the present invention, when the transformation matrix is applied to the DUT, the transformation matrix may be configured to correct errors related to laser skew, azimuthal direction errors, and elevational direction FOV offsets of the DUT.

To achieve the above object of the present invention, there is provided a calibration method for a LIDAR device using a calibration device, the method comprising: controlling the DUT to perform scanning of a plurality of fiducial marks and record a frame based on the scanning; controlling the DUT to generate a GmAPD (Geiger-mode Avalanche PhotoDiode)-based image including pixels corresponding to each of the fiducial marks based on the frame; identifying three-dimensional coordinate data for a center of each of the fiducial marks from the GmAPD-based image; performing line fitting among the centers of the fiducial marks based on the identified three-dimensional coordinate data; and computing a laser skew angle of the DUT based on the line fitting.

According to an embodiment of the present invention, the step of controlling the DUT to perform scanning of a plurality of fiducial marks and record the frame based on the scanning may include: controlling the azimuthal rotation adjusting unit included in the calibration device to rotate the DUT in a azimuthal direction by a defined angle; and controlling the DUT to perform the scanning of the fiducial marks while rotating by the defined angle.

According to an embodiment of the present invention, the fiducial marks may be arranged to be spaced apart from each of the DUT and the calibration device by a same distance.

According to an embodiment of the present invention, one of the fiducial marks may be arranged to be located at one end of a azimuthal direction FOV of the DUT when the DUT starts azimuthal rotation, and the other of the fiducial marks may be arranged to be located at the other end of the azimuthal direction FOV of the DUT when the DUT ends the azimuthal rotation.

To achieve the above object of the present invention, there is provided a calibration method for a LIDAR device using a calibration device, the method comprising: controlling a elevational rotation adjusting unit included in the calibration device to rotate the DUT in a elevational direction in N rotation steps; controlling the DUT to perform scanning with respect to at least one of the fiducial marks at each of the N rotation steps and record a frame based on the scanning; controlling the DUT to generate a GmAPD (Geiger-mode Avalanche PhotoDiode)-based image based on the frame; and computing an azimuthal direction error of the DUT based on the GmAPD-based image.

According to an embodiment of the present invention, the GmAPD-based image may include a pixel corresponding to the fiducial mark.

According to an embodiment of the present invention, the step of computing the azimuthal direction error of the DUT based on the GmAPD-based image may include: identifying azimuthal direction coordinate data with respect to a center of the fiducial mark from the GmAPD-based image; calculating a deviation value between the azimuthal direction coordinate data and reference data for the azimuthal direction coordinate data; and computing the azimuthal direction error of the DUT based on the deviation value.

To achieve the above object of the present invention, there is provided a calibration method for a LIDAR device using a calibration device, the method comprising: controlling a azimuthal rotation adjusting unit included in the calibration device to rotate the DUT in a elevational direction in N rotation steps; controlling the DUT to perform scanning with respect to at least one of the fiducial marks at each of the N rotation steps and record a frame based on the scanning; controlling the DUT to generate a GmAPD (Geiger-mode Avalanche PhotoDiode)-based image based on the frame; and computing an elevational direction FOV offset of the DUT based on the GmAPD-based image.

According to an embodiment of the present invention, the GmAPD-based image may include a pixel corresponding to the fiducial mark.

According to an embodiment of the present invention, the step of computing the elevational direction FOV offset of the DUT based on the GmAPD-based image may include: identifying elevational direction coordinate data with respect to a center of the fidcial mark from the GmAPD-based image; calculating a deviation value between the elevational direction coordinate data and reference data for the elevational direction coordinate data; and computing the elevational direction FOV offset of the DUT based on the deviation value.

To achieve the above object of the present invention, there is provided a calibration method for a LIDAR device using a calibration device, the method comprising: controlling the DUT to perform scanning of at least one target and record a plurality of frames based on the scanning; controlling the DUT to generate a GmAPD (Geiger-mode Avalanche PhotoDiode)-based image including a pixel corresponding to the target based on the frame; identifying pixels of the GmAPD-based image corresponding to the target on the GmAPD-based image; selecting at least some of the identified pixels; computing an evaluation value for the selected pixels; computing an evaluation result for the evaluation value based on a defined criterion; and adjusting parameters for each of a plurality of pixels included in the DUT based on the evaluation result.

According to an embodiment of the present invention, when the at least one target comprises a plurality of targets, the plurality of targets may be configured such that at least one of reflectivity and distance is different from one another.

According to an embodiment of the present invention, the step of identifying pixels of the GmAPD-based image corresponding to the target on the GmAPD-based image may include: identifying azimuthal direction coordinate data and elevational direction coordinate data included in each of the pixels of the GmAPD-based image corresponding to the target; and identifying a minimum value and a maximum value with respect to each of the azimuthal direction coordinate data and the elevational direction coordinate data.

According to an embodiment of the present invention, the step of selecting at least some of the identified pixels may be performed based on the minimum value and the maximum value with respect to each of the azimuthal direction coordinate data and the elevational direction coordinate data.

According to an embodiment of the present invention, the evaluation value may be at least one selected from the group consisting of a true positive rate and a false positive rate for distance information calculated by the DUT, an average and a standard deviation of distance bias, and an average of signal intensity.

According to an embodiment of the present invention, the evaluation result may be output depending on whether the evaluation value falls within a defined numerical range.

### Effect of the Invention

A calibration device and method according to the present invention may compute geometric offsets and/or range offsets for a LIDAR device and apply the computed offsets to the LIDAR device.

### BRIEF DESCRIPTION OF THE FIGURES

FIG. 1 is a schematic diagram illustrating an operation of an light detection and ranging device or a LIDAR device according to an embodiment of the present invention.

FIG. 2 is a diagram illustrating a calibration device for a LIDAR device according to an embodiment of the present invention.

FIG. 3 is a flowchart illustrating a method of determining a azimuthal direction offset of a LIDAR device using a calibration device according to an embodiment of the present invention.

FIG. 4 is an exemplary diagram illustrating generation of an i-th GmAPD-based image by applying an i-th test offset to the LIDAR device in connection with the method illustrated in FIG. 3.

FIG. 5 is an exemplary diagram illustrating determination of a azimuthal direction offset of an encoder by a least-square method in connection with the method illustrated in FIG. 3.

FIG. 6 is a flowchart illustrating a method of computing an optimal transformation matrix for a LIDAR device based on a G-ICP algorithm using a calibration device according to an embodiment of the present invention.

FIG. 7 is a flowchart illustrating a method of computing a laser skew angle of a LIDAR device using a calibration device and fiducial marks according to an embodiment of the present invention.

FIG. 8 is an exemplary diagram illustrating computation of a laser skew angle based on line fitting among centers of fiducial marks in connection with the method illustrated in FIG. 7.

FIG. 9 is a flowchart illustrating a method of computing a azimuthal direction error and an elevational direction FOV offset of a LIDAR device using a calibration device and fiducial marks according to an embodiment of the present invention.

FIG. 10 is a flowchart illustrating a method of correcting distance-information errors for respective pixels of a point cloud calculated by a LIDAR device using a calibration device and a target according to an embodiment of the present invention.

FIG. 11 is an exemplary diagram illustrating an arrangement among a LIDAR device, a calibration device, fiducial marks, and targets for performing the methods illustrated in FIGS. 3, 6, 7, 9, and 10.

### DETAILED DESCRIPTION

Hereinafter, a calibration device and system for a LIDAR device according to embodiments of the present invention, and a calibration method for the LIDAR device using the same, will be described in detail with reference to the accompanying drawings. It will be readily understood by those skilled in the art that the accompanying drawings are provided merely for more easily disclosing the features of the present invention, and that the scope of the present invention is not limited to the scope illustrated in the drawings.

### Prefatory Description

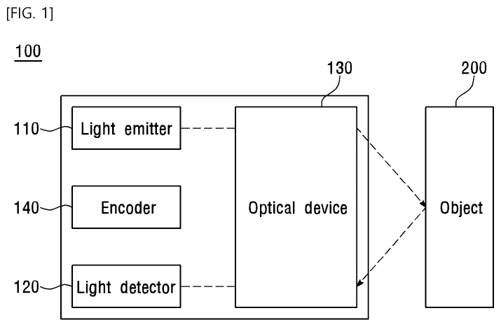

FIG. 1 is a schematic diagram illustrating an operation of a light detection and ranging device or a LIDAR device to which the present invention is applied.

Referring to FIG. 1, an light detection and ranging device 100 (hereinafter, also referred to as a LIDAR device) to which the present invention is applied may include a light emitter 110 configured to emit light, a light detector 120 configured to detect reflected light returning after being reflected from an object 200, and an optical device 130 provided on optical paths along which light is emitted and received by the light emitter 110 and the light detector 120. Here, the light emitter 110 may be a diode or a laser light source. The LIDAR device may compute a range or a property of the object 200 using the reflected light returning from the object 200.

Referring to FIG. 1, the LIDAR device 100 may further include an encoder 140. Specifically, the encoder 140 is a component configured to measure a rotation angle of a scanning mechanism of the LIDAR device 100 and convert the measured angle into an electrical signal. The encoder 140 may be configured to provide, in real time, data on a azimuthal angle and/or a elevational angle corresponding to a rotational position of the LIDAR device 100.

More specifically, the encoder 140 may play an important role in associating pulses of light emitted from the light emitter 110 with accurate directional data. The LIDAR device 100 may compute a 3D point cloud representing a surrounding environment by combining the angle data provided from the encoder 140 with distance data collected by the LIDAR device 100.

In the present specification, a device under test (DUT) may be interchangeably referred to as a LIDAR device.

A point cloud refers to a collection of data points in a 3D space. A collection of data points computed by the LIDAR device to which the present invention is applied may also be referred to as a point cloud. Since distances among the data points constituting a point cloud are generally non-uniform, it is preferable to encode all three coordinates (Cartesian coordinates or spherical coordinates) specifically for each of the points.

According to the present invention, a device to be inspected is referred to as a device under test (DUT, Device Under Test).

Among results indicating that a measurement value is positive, a case in which the measurement value is actually correct—that is, a case in which the measurement value is positive and the result is also positive—is referred to as a true positive (TP). Among results indicating that a measurement value is positive, a case in which the measurement value is not correct—that is, a case in which the measurement value is positive but the result is negative—is referred to as a false positive (FP).

A probability of valid points in a single measurement of a single target and/or in multiple accumulated measurements is referred to as a probability of detection (POD) or a true positive rate. The probability of detection may depend on background noise, reflectivity of the target, allowable error of range, and other properties. The POD may be calculated by the following Equation 1, wherein a true positive (TP) represents scan points that correctly hit an actually detected target within a range of distance (actual)±Δ. The probability of detection is calculated as a ratio of the number of valid points to the theoretical number of points.

$$PoD ( d = … m ) \vert = \frac{{\sum }_{i = 1}^{i = n} TP}{{\sum }_{i = 1}^{i = n} 1} \qquad [ Equation 1 ]$$

Conversely, a probability that a false positive occurs in a single measurement of a single target and/or in multiple accumulated measurements is referred to as a false positive rate.

In a point cloud of a LIDAR device, an angle between two outermost valid points in which the POD exceeds 50% (for a Lambertian target having a reflectivity of 50%) is referred to as a field of view (FOV). The FOV includes an azimuthal FOV and an elevational FOV.

Capturing an entire FOV (azimuthal/elevational) is referred to as a frame.

Measurement precision refers to a distribution of measurement values obtained through repeated measurements of the same object under specific conditions. In general, measurement precision is provided as a standard deviation.

Measurement accuracy refers to a measure indicating a degree of difference between a measured mean value and a true value.

Range precision refers to measurement precision of a range result value.

Range accuracy refers to measurement accuracy of a range result value.

A pixel of the LIDAR device 100 is an individual unit constituting a light detection region of the light detector 120 of the LIDAR device. Each pixel collects light reflected from a specific direction and generates, based thereon, distance and/or depth information, that is, a range result value. Meanwhile, a pixel of the LIDAR device 100 may be distinguished from a pixel included in a predetermined image (e.g., a GmAPD-based image described below) generated by the LIDAR device 100.

A channel of the LIDAR device 100 is a group of predetermined pixel(s) arranged elevationally in an optical and electrical structure of the LIDAR device 100.

Range bias refers to a difference between a range result value generated by a pixel and an actual value. Range bias may serve as a criterion for determining range accuracy of the LIDAR device 100.

### Calibration Device

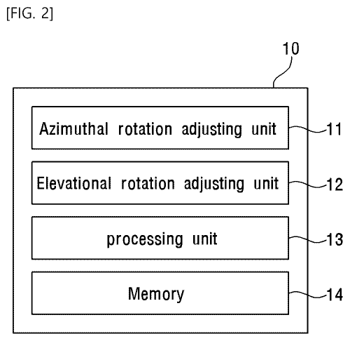

FIG. 2 is a diagram illustrating a calibration device for a LIDAR device according to an embodiment of the present invention.

According to an embodiment of the present invention, a calibration device 10 is a device configured to perform correction or calibration for the LIDAR device 100.

As illustrated in FIG. 2, the calibration device 10 may include a azimuthal rotation adjusting unit 11, a elevational rotation adjusting unit 12, a processing unit 13, and a memory unit 14.

Specifically, the azimuthal rotation adjusting unit 11 is configured to rotate the LIDAR device 100, which is the DUT, in an azimuthal direction.

Specifically, the elevational rotation adjusting unit 12 is configured to rotate the LIDAR device 100, which is the DUT, in an elevational direction.

Specifically, the processing unit 13 may control operations of the azimuthal rotation adjusting unit 11 and the elevational rotation adjusting unit 12. In addition, the processing unit 13 may control an operation of the DUT, that is, the LIDAR device 100 connected to the calibration device 10. Further, the processing unit 13 may process information output by the LIDAR device 100, the azimuthal rotation adjusting unit 11, and the elevational rotation adjusting unit 12, and may perform calibration of the LIDAR device 100 based on the processed information.

Specifically, the memory unit 14 may store information output from the DUT, that is, the LIDAR device 100 connected to the calibration device 10. In addition, the memory unit 14 may store information generated by the processing unit 13 based on the information output from the LIDAR device 100. The memory unit 14 may also store a program configured to enable the processing unit 13 to perform the above-described operations.

### Encoder Offset

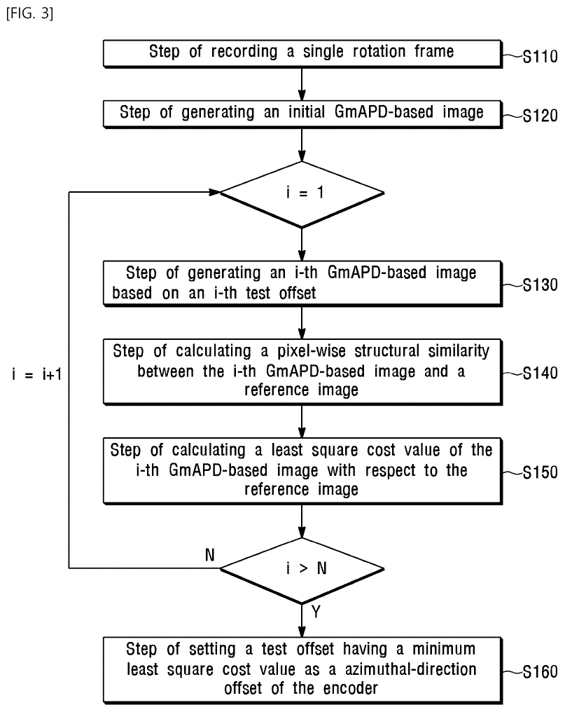

FIG. 3 is a flowchart illustrating a method of determining a azimuthal direction offset of a LIDAR device using a calibration device according to an embodiment of the present invention.

According to an embodiment of the present invention, the azimuthal direction offset of the LIDAR device 100 may refer to an offset of the encoder 140. Specifically, the offset of the encoder 140 may be an angular deviation between an actual rotational position of a scanning mechanism of the LIDAR device 100 and a rotational position detected by the encoder 140.

As illustrated in FIG. 3, a method of determining a azimuthal direction offset of the LIDAR device 100 using the calibration device 10 may include: recording a single-rotation frame (S110); generating an initial GmAPD-based image (S120); generating an i-th GmAPD-based image based on an i-th test offset (S130); calculating pixel-wise structured similarity between the i-th GmAPD-based image and a reference image (S140); computing a least square cost value of the i-th GmAPD-based image with respect to the reference image (S150); and determining a test offset having a minimum least square cost value as a azimuthal direction offset of the encoder (S160).

In an embodiment of the present invention, steps S130 to S150 may be repeatedly performed from i=1 to i=N (where Nis an integer equal to or greater than 1), for a total of N iterations.

In step S110, recording a single-rotation frame may mean that the LIDAR device 100 rotates 360 degrees in the azimuthal direction and records one frame. More specifically, a set of data collected during 360-degree scanning by the LIDAR device 100 may be treated as a single frame. At this time, the LIDAR device 100 may perform a single rotation starting from an angular position detected as a reference point (0 degrees) by the encoder 140.

In an embodiment of the present invention, step S110 may be performed by the processing unit 13 of the calibration device 10. More specifically, the processing unit 13 may control the azimuthal rotation adjusting unit 11 to rotate the LIDAR device 100 by a single rotation. In addition, the processing unit 13 may control the LIDAR device 100 to record the above-described single frame during the single rotation.

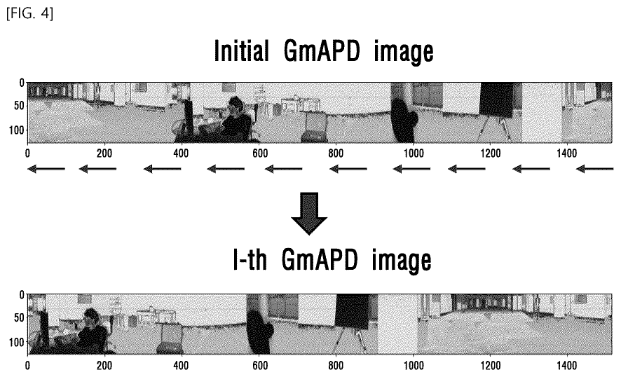

FIG. 4 is an exemplary diagram illustrating generation of an i-th GmAPD-based image by applying an i-th test offset to the LIDAR device in connection with the method illustrated in FIG. 3.

In step S120, generating an initial GmAPD (Geiger-mode Avalanche PhotoDiode)-based image may mean generating a GmAPD-based image based on the single-rotation frame recorded by the LIDAR device 100. The GmAPD-based image may be in a form of a 2D image, and each pixel included in the image may include information regarding a position of a corresponding object, a distance to the object, and intensity of reflected light from the object (see FIG. 4). More specifically, the initial GmAPD-based image may refer to a GmAPD-based image generated by the LIDAR device 100 without applying any offset to the encoder 140.

Meanwhile, step S120 may be performed by the processing unit 13 of the calibration device 10. More specifically, the processing unit 13 may control the LIDAR device 100 to generate a GmAPD-based image based on the single-rotation frame.

In step S130, the processing unit 13 may apply an i-th test offset to the encoder 140 of the LIDAR device 100, and may control the LIDAR device 100 to generate an i-th GmAPD-based image based on the i-th test offset. Specifically, as illustrated in FIG. 4, when the i-th test offset is applied to the encoder 140, an object and/or a position of the object corresponding to each pixel on the GmAPD-based image generated by the LIDAR device 100 may vary. That is, as a result, an effect identical to shifting a starting point of a single rotation of the LIDAR device 100 by the amount of the test offset from an angular position detected as a reference point (0 degrees) by the encoder 140 may occur.

Meanwhile, from i=1 to i=N, a value of the test offset may increase linearly or non-linearly. In addition, from i=1 to i=N, the value of the test offset may increase continuously, although it is not limited thereto.

In step S140, the processing unit 13 may calculate a pixel-wise structured similarity cost between the i-th GmAPD-based image generated by the LIDAR device 100 and a reference image. Here, the structured similarity cost is an index for measuring similarity between images, and is used to quantitatively evaluate a degree of similarity between images by comparing luminance, contrast, structure, and the like.

Meanwhile, the reference image may refer to a GmAPD-based image generated based on a single-rotation frame recorded for the same object using a predetermined LIDAR sensor having better performance than the DUT, that is, the LIDAR device 100. However, the present invention is not limited thereto.

In step S150, the processing unit 13 may compute a least square cost value of the i-th GmAPD-based image with respect to the reference image based on the pixel-wise structured similarity cost calculated in step S140.

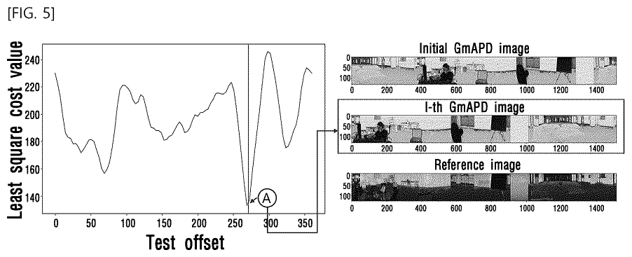

When steps S130 to S150 are repeatedly performed from i=1 to i=N, a total of N least square cost values corresponding to the N test offsets may be obtained (see FIG. 5).

FIG. 5 is an exemplary diagram illustrating a process of determining a azimuthal direction offset of the encoder by a least-square method in connection with the method illustrated in FIG. 3.

In step S160, the processing unit 13 may control the LIDAR device 100 such that a test offset having a minimum least square cost value becomes a azimuthal direction offset of the encoder 140. For example, as illustrated in FIG. 5, a test offset corresponding to a point A, at which the least square cost value is the smallest, may be set as the azimuthal direction offset of the encoder 140. As illustrated in FIG. 5, it can be seen that an i-th GmAPD-based image corresponding to point A is similar to the reference image compared to the initial GmAPD-based image.

### Optimal Transformation Matrix Based on G-ICP Algorithm

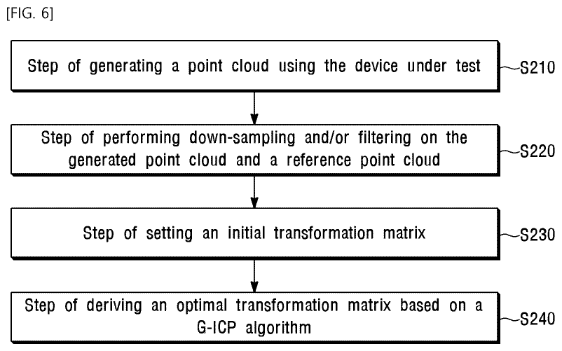

FIG. 6 is a flowchart illustrating a method of computing an optimal transformation matrix for a LIDAR device based on a G-ICP algorithm using a calibration device according to an embodiment of the present invention.

According to an embodiment of the present invention, the optimal transformation matrix is configured to correct measurement errors caused by a laser skew angle, an azimuthal direction error, and an elevational direction FOV offset of the LIDAR device 100.

As illustrated in FIG. 6, a method of computing an optimal transformation matrix for the LIDAR device 100 based on a G-ICP algorithm using the calibration device may include: computing a point cloud using the DUT, that is, the LIDAR device 100 (S210); performing down sampling and/or filtering on the computed point cloud and a reference point cloud (S220); setting an initial transformation matrix (S230); and computing an optimal transformation matrix based on the G-ICP algorithm (S240).

In step S210, the processing unit 13 may control the DUT, that is, the LIDAR device 100, to scan a predetermined object and compute a point cloud for the object.

In step S220, the processing unit 13 may perform down sampling and/or filtering on the point cloud computed by the LIDAR device 100.

In addition, in step S220, the processing unit 13 may perform down sampling and/or filtering on a reference point cloud distinguished from the point cloud computed by the LIDAR device 100.

Here, the reference point cloud corresponds to the point cloud computed by the LIDAR device 100, and may be a point cloud computed for the same object by a predetermined LIDAR sensor having better performance than the DUT, that is, the LIDAR device 100. However, the present invention is not limited thereto.

Down sampling is a process of reducing data density in a point cloud obtained from the LIDAR device, and is intended to improve computational efficiency and reduce processing time. Specifically, down sampling is performed by selecting a portion of the data at certain intervals or according to certain criteria from high-density data to reduce the number of points, thereby maintaining major structural features of the data while reducing processing burdens.

Filtering is intended to remove unnecessary or abnormal data, such as outliers, ground, and ceiling points, from the point cloud. Filtering may be performed to improve data quality and enhance accuracy of analysis or alignment in subsequent steps. By filtering noise or abnormal points included in data generated by the LIDAR device 100, reliability and processing efficiency of the data may be significantly improved.

In step S230, the processing unit 13 may generate a 4×4 initial transformation matrix and apply the initial transformation matrix to the LIDAR device 100. The transformation matrix is used to perform 3D alignment on the point cloud computed by the LIDAR device 100. For example, the transformation matrix may be used to transform the point cloud computed by the LIDAR device 100 such that it matches a point cloud computed by a predetermined LIDAR sensor having better performance than the LIDAR device 100. Here, the transformation matrix may be configured in a form shown in the following Equation 2.

$$T = [ \begin{matrix}{R}_{3 \times 3} & {t}_{3 \times 1} \\ {0}_{1 \times 3} & 1\end{matrix} ] \qquad [ Equation 2 ]$$

(Here,
R_{3×3}: a 3×3 matrix representing rotation (rotation matrix),
t_{3×1}: a 3×1 vector representing translation (translation vector), and
0_{1×3} and 1: elements for maintaining homogeneous coordinates of the matrix.)

In step S240, the processing unit 13 may compute an optimal transformation matrix based on a G-ICP (Generalized Iterative Closest Point) algorithm. Specifically, a method of computing the optimal transformation matrix based on the G-ICP algorithm may include:

matching pairs of closest data points between the point cloud computed by the DUT, that is, the LIDAR device 100, and the reference point cloud based on the initial transformation matrix set in step S230; defining a cost function based on a covariance matrix for each pair of data points; computing a transformation matrix that minimizes the cost function through a predetermined optimization process; and returning the optimal transformation matrix in response to a change in the transformation matrix converging to equal to or less than a set threshold. However, the present invention is not limited thereto.

According to an embodiment of the present invention, the processing unit 13 may apply information on the optimal transformation matrix computed through steps S210 to S240 to the DUT, that is, the LIDAR device 100. In this case, the LIDAR device 100 may apply the optimal transformation matrix to a point cloud computed by the LIDAR device 100 and correct errors related to a laser skew angle, an azimuthal direction error, and an elevational direction FOV offset.

### Computation of Laser Skew Angle Using Fiducial Marks

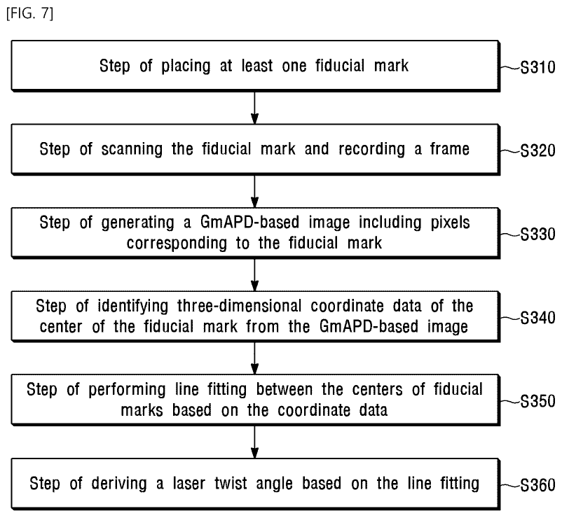

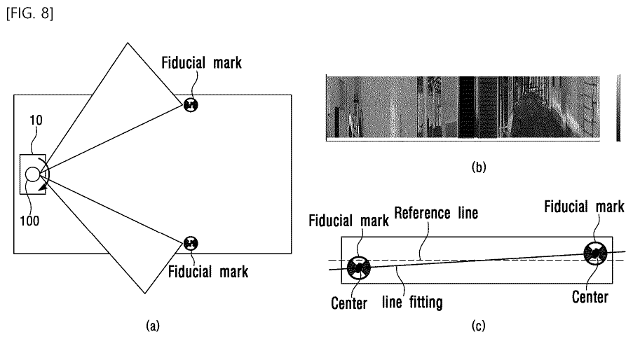

FIG. 7 is a flowchart illustrating a method of computing a laser skew angle of a LIDAR device using a calibration device and fiducial marks according to an embodiment of the present invention. FIG. 8 is an exemplary diagram illustrating computation of a laser skew angle based on line fitting among centers of fiducial marks in connection with the method illustrated in FIG. 7. Specifically, FIG. 8(a) is a conceptual diagram illustrating an operation in which the LIDAR device scans fiducial marks and records a frame. FIG. 8(b) illustrates an example of a GmAPD-based image generated by the LIDAR device. FIG. 8(c) is a conceptual diagram illustrating an operation in which the calibration device performs line fitting among centers of the fiducial marks.

As illustrated in FIG. 7, a method of computing a laser skew angle of a LIDAR device using a calibration device and fiducial marks may include: arranging at least one fiducial mark (S310); scanning the fiducial mark and recording a frame (S320); generating a GmAPD-based image including a pixel corresponding to the fiducial mark (S330); identifying three-dimensional coordinate data for a center of the fiducial mark from the GmAPD-based image (S340); performing line fitting among centers of the fiducial marks based on the three-dimensional coordinate data (S350); and computing a laser skew angle based on the line fitting (S360).

In step S310, at least one fiducial mark may be arranged in a space to be scanned by the LIDAR device 100. Alternatively, a plurality of fiducial marks, for example, two fiducial marks, may be arranged in the space. However, the present invention is not limited thereto.

According to an embodiment of the present invention, a fiducial mark may be a special mark fixed in an environment for calibration of the DUT. The fiducial mark may provide reference coordinates in data collected by the LIDAR device 100. Alternatively, the fiducial mark may allow the LIDAR device 100 to recognize the fiducial mark so that predetermined position and orientation information can be reflected in a calibration process. Alternatively, the fiducial mark may serve as a consistent reference point when performing registration between data sets computed by the LIDAR device 100.

According to an embodiment of the present invention, a fiducial mark may generally be configured as a fixed physical structure and may include a high-contrast pattern designed to be easily detected by the LIDAR device 100. For example, the fiducial mark may include a mark formed of a highly reflective material, or a point or line structure having a predetermined size and shape. However, the present invention is not limited thereto.

For example, when two fiducial marks are arranged, each fiducial mark may be placed at an equal distance from the DUT, that is, the LIDAR device 100.

In step S320, the processing unit 13 may control the LIDAR device 100 to scan a space in which fiducial marks are arranged and record a frame. Specifically, the processing unit 13 may control the azimuthal rotation adjusting unit 11 to rotate the LIDAR device 100 by a predetermined angle. In addition, the processing unit 13 may control the LIDAR device 100 to scan the space in which the fiducial marks are arranged and to record the frame while the LIDAR device 100 rotates.

Meanwhile, as illustrated in FIG. 8(a), at least one of the fiducial marks may be arranged such that it is located at one end of a azimuthal FOV range of the LIDAR device 100 at a timing when the LIDAR device 100 starts azimuthal rotation. In addition, another fiducial mark may be arranged such that it is located at the other end of the azimuthal FOV range of the LIDAR device 100 at a timing when the LIDAR device 100 completes azimuthal rotation. However, the present invention is not limited thereto.

In step S330, as illustrated in FIGS. 8(b) and 8(c), the processing unit 13 may control the LIDAR device 100 to generate a GmAPD-based image including a pixel corresponding to the fiducial mark.

As illustrated in FIG. 8(c), a GmAPD-based image generated by the LIDAR device 100 may include a pixel corresponding to the fiducial mark. Based on the GmAPD-based image, the processing unit 13 may identify three-dimensional coordinate data for a center of the fiducial mark. In addition, the processing unit 13 may perform line fitting among centers of the fiducial marks based on the three-dimensional coordinate data. Further, the processing unit 13 may compute a laser skew angle of the LIDAR device 100 based on the line fitting. In this case, the processing unit 13 may compute the laser skew angle based on information about a predetermined reference line inherently stored in the calibration device. However, the present invention is not limited thereto.

### Azimuthal Direction Error and Elevational Direction FOV Offset

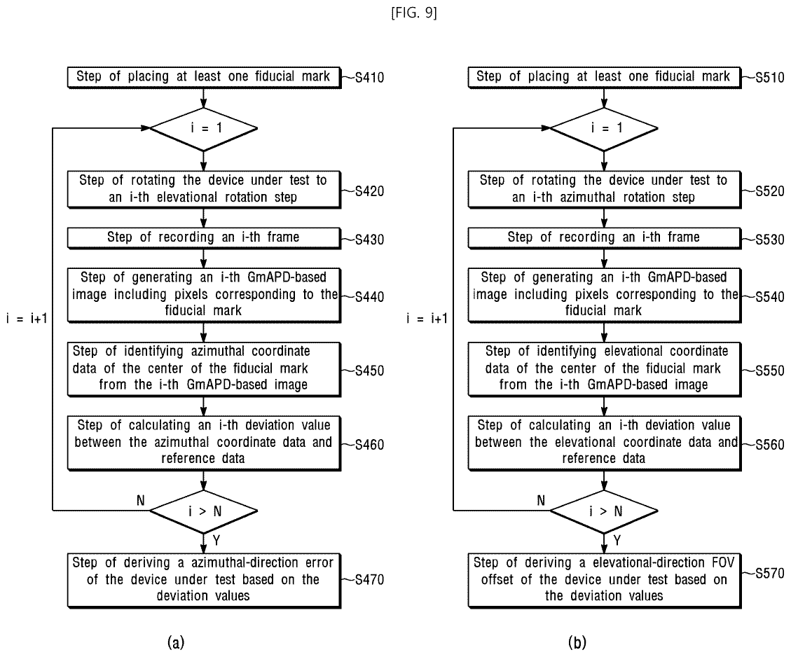

FIG. 9 is a flowchart illustrating a method of computing an azimuthal direction error and an elevational direction FOV offset of a LIDAR device using a calibration device and fiducial marks according to an embodiment of the present invention. Specifically, FIG. 9(a) illustrates a flowchart of a method of computing an azimuthal direction error of a LIDAR device. FIG. 9(b) illustrates a flowchart of a method of computing an elevational direction FOV offset of a LIDAR device.

As illustrated in FIG. 9(a), a method of computing an azimuthal direction error of the LIDAR device 100 may include: arranging at least one fiducial mark (S410); rotating the DUT, that is, the LIDAR device 100, to an i-th elevational rotation step (S420); recording an i-th frame (S430); generating an i-th GmAPD-based image including a pixel corresponding to at least one fiducial mark (S440); identifying azimuthal direction coordinate data for a center of the fiducial mark from the i-th GmAPD-based image (S450); calculating an i-th deviation value between the azimuthal direction coordinate data and reference data for the center of the fiducial mark (S460); and computing an azimuthal direction error of the DUT, that is, the LIDAR device 100, based on the deviation values (S470).

In step S420, the processing unit 13 may control the elevational rotation adjusting unit 12 to rotate the DUT, that is, the LIDAR device 100, elevationally to the i-th elevational rotation step.

In step S430, the processing unit 13 may control the LIDAR device 100 to record the i-th frame. Specifically, the i-th frame may be a frame recorded by the LIDAR device 100 at the i-th elevational rotation step.

In step S440, the processing unit 13 may control the LIDAR device 100 to generate the i-th GmAPD-based image. Specifically, the i-th GmAPD-based image may be an image generated by the LIDAR device 100 based on the i-th frame. In addition, the i-th GmAPD-based image may include a pixel corresponding to at least one fiducial mark. For example, the GmAPD-based image may include a pixel corresponding to one fiducial mark, although the present invention is not limited thereto.

In step S450, the processing unit 13 may identify azimuthal direction coordinate data for a center of the fiducial mark from the i-th GmAPD-based image.

In step S460, the processing unit 13 may calculate the i-th deviation value between the reference data and the azimuthal direction coordinate data for the center of the fiducial mark. Specifically, the reference data may refer to a reference value of the azimuthal direction coordinate data for the center of the fiducial mark. The reference data may refer to data computed by a predetermined LIDAR sensor having better performance than the DUT, that is, the LIDAR device 100.

In step S470, the processing unit 13 may compute an azimuthal direction error of the DUT, that is, the LIDAR device 100, based on a total of N deviation values from i=1 to i=N. Specifically, the processing unit 13 may accumulate the N deviation values and compute the azimuthal direction error of the LIDAR device 100 by applying statistical processing and/or a predetermined algorithm thereto.

The computed azimuthal direction error may be input to the DUT, that is, the LIDAR device 100, by the processing unit 13. A value of the input azimuthal direction error may be applied to a point cloud computed by the LIDAR device 100, and accordingly, calibration for an azimuthal direction error inherent in the point cloud may be performed.

As illustrated in FIG. 9(b), a method of computing an elevational direction FOV offset of the LIDAR device 100 may include: arranging at least one fiducial mark (S510); rotating the DUT, that is, the LIDAR device 100, to an i-th azimuthal rotation step (S520); recording an i-th frame (S530); generating an i-th GmAPD-based image including a pixel corresponding to at least one fiducial mark (S540); identifying elevational direction coordinate data for a center of the fiducial mark from the i-th GmAPD-based image (S550); calculating an i-th deviation value between the elevational direction coordinate data and reference data for the center of the fiducial mark (S560); and computing an elevational direction FOV offset of the DUT, that is, the LIDAR device 100, based on the deviation values (S570).

In step S520, the processing unit 13 may control the azimuthal rotation adjusting unit 11 to rotate the DUT, that is, the LIDAR device 100, azimuthally to the i-th azimuthal rotation step.

In step S530, the processing unit 13 may control the LIDAR device 100 to record the i-th frame. Specifically, the i-th frame may be a frame recorded by the LIDAR device 100 at the i-th azimuthal rotation step.

In step S540, the processing unit 13 may control the LIDAR device 100 to generate the i-th GmAPD-based image. Specifically, the i-th GmAPD-based image may be an image generated by the LIDAR device 100 based on the i-th frame. In addition, the i-th GmAPD-based image may include a pixel corresponding to at least one fiducial mark. For example, the GmAPD-based image may include a pixel corresponding to one fiducial mark, although the present invention is not limited thereto.

In step S550, the processing unit 13 may identify elevational direction coordinate data for a center of the fiducial mark from the i-th GmAPD-based image.

In step S560, the processing unit 13 may calculate the i-th deviation value between the reference data and the elevational direction coordinate data for the center of the fiducial mark. Specifically, the reference data may refer to a reference value of the elevational direction coordinate data for the center of the fiducial mark. The reference data may refer to data computed by a predetermined LIDAR sensor having better performance than the DUT, that is, the LIDAR device 100.

In step S570, the processing unit 13 may compute an elevational direction FOV offset of the DUT, that is, the LIDAR device 100, based on a total of N deviation values from i=1 to i=N. Specifically, the processing unit 13 may accumulate the N deviation values and compute the elevational direction FOV offset of the LIDAR device 100 by applying statistical processing and/or a predetermined algorithm thereto.

The computed elevational direction FOV offset may be input to the DUT, that is, the LIDAR device 100, by the processing unit 13. A value of the input elevational direction FOV offset may be applied to a point cloud computed by the LIDAR device 100, and accordingly, calibration for an elevational direction FOV offset inherent in the point cloud may be performed.

### Correction of Errors in Range Information

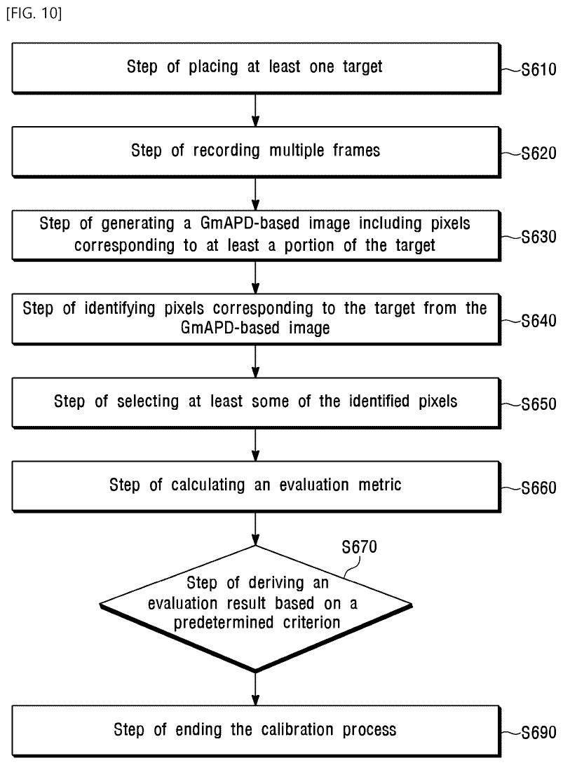

FIG. 10 is a flowchart illustrating a method of correcting errors in range information on a pixel-by-pixel basis in a point cloud computed by a LIDAR device using a calibration device and targets according to an embodiment of the present invention.

As illustrated in FIG. 10, a method of correcting errors in depth information on a pixel-by-pixel basis in a point cloud computed by a LIDAR device may include: arranging at least one target (S610); recording a plurality of frames (S620); generating a GmAPD-based image including a pixel corresponding to at least some of the at least one target (S630); identifying a pixel on the GmAPD-based image corresponding to a target (S640); selecting at least some of the identified pixels (S650); computing an evaluation value (S660); computing an evaluation result for the evaluation value based on a predetermined criterion (S670); adjusting parameters for each pixel of the DUT, that is, the LIDAR device 100, based on the evaluation result (S680); and an end step (S690).

In step S610, a plurality of targets may be arranged in a space in which scanning is performed by the DUT, that is, the LIDAR device 100. Specifically, the plurality of targets may be arranged with different reflectivities and/or distances. Here, at least some of the targets may be the above-described fiducial marks, although the present invention is not limited thereto.

In step S620, the processing unit 13 may control the LIDAR device 100 to record a plurality of frames. Specifically, the LIDAR device 100 may emit light toward the space in which the targets are arranged, collect light reflected from the targets, and record a plurality of frames. For example, the plurality of frames may include one hundred frames, although the present invention is not limited thereto.

In step S630, the processing unit 13 may control the LIDAR device 100 to generate a GmAPD-based image including a pixel corresponding to at least some of the at least one target. For example, when a single target is arranged, the LIDAR device 100 may generate a GmAPD-based image including a pixel corresponding to the single target. However, the present invention is not limited thereto.

Meanwhile, the LIDAR device 100 may generate a GmAPD-based image based on the recorded plurality of frames.

In step S640, the processing unit 13 may identify a pixel corresponding to a target on the GmAPD-based image. Specifically, the processing unit 13 may segment a pixel region corresponding to the target on the GmAPD-based image. More specifically, the processing unit 13 may identify azimuthal direction coordinate data and elevational direction coordinate data included in each pixel corresponding to the target on the GmAPD-based image. In addition, the processing unit 13 may identify minimum and maximum values of the identified azimuthal and elevational direction coordinate data.

In step S650, the processing unit 13 may select at least some of the pixels identified on the GmAPD-based image. Specifically, the processing unit 13 may select a portion of the pixels based on minimum and maximum values of azimuthal and elevational direction coordinate data included in each pixel on the GmAPD-based image. For example, the processing unit 13 may select pixels excluding those whose azimuthal direction coordinate data belong to an upper 25% range or a lower 25% range among all pixels on the GmAPD-based image. However, a specific numerical range is not limited to this example. Furthermore, a process of selecting a portion of the pixels may be performed for the azimuthal direction and/or the elevational direction.

In step S660, the processing unit 13 may compute an evaluation value for the selected pixel(s). For example, the evaluation value may include at least one value selected from a group consisting of a true positive rate for range information computed by the DUT, that is, the LIDAR device 100, a false positive rate, an average or standard deviation of a range bias, and an average signal intensity. However, the present invention is not limited thereto.

In step S670, the processing unit 13 may compute an evaluation result for the computed evaluation value based on a predetermined criterion. Specifically, the processing unit 13 may output a pass or fail evaluation result depending on whether the evaluation value falls within a predetermined numerical range.

For example, when the evaluation value is a true positive rate, the processing unit 13 may output a pass evaluation result when the computed true positive rate falls within a numerical range of [0.95, 1].

For example, when the evaluation value is a false positive rate, the processing unit 13 may output a pass evaluation result when the computed false positive rate falls within a numerical range of [0, 0.01].

For example, when the evaluation value is an average range bias, the processing unit 13 may output a pass evaluation result when the computed average range bias falls within a numerical range of [−0.05, 0.05].

For example, when the evaluation value is a standard deviation of range bias, the processing unit 13 may output a pass evaluation result when the computed standard deviation of range bias is equal to or less than 0.05.

For example, when the evaluation value is an average signal intensity, the processing unit 13 may output a pass evaluation result when the computed average signal intensity falls within a predetermined numerical range. In this case, the predetermined numerical range may vary depending on a distance to the target and/or a reflectivity of the target.

The above numerical ranges are only illustrative, and a numerical range used in a method according to the present invention may vary depending on at least one factor selected from a group consisting of a type of the target, a distance to the target, a reflectivity of the target, and an environment of measurement.

Referring to step S680, when the processing unit 13 outputs a fail evaluation result for the evaluation value computed by the DUT, that is, the LIDAR device 100, in step S670, the processing unit 13 may adjust at least one parameter for each pixel of the LIDAR device 100 based on the evaluation result. Specifically, a parameter may refer to a hardware or software setting of the LIDAR device 100 that affects the evaluation value computed by the LIDAR device 100.

As illustrated in FIG. 10, after step S680 is performed, steps S660 and S670 may be performed again.

Referring to step S690, when the processing unit 13 outputs a pass evaluation result for the evaluation value computed by the DUT, that is, the LIDAR device 100, in step S670, a calibration process may be terminated. In this case, parameters adjusted by step S680 may remain applied to the LIDAR device 100.

### Target Arrangement

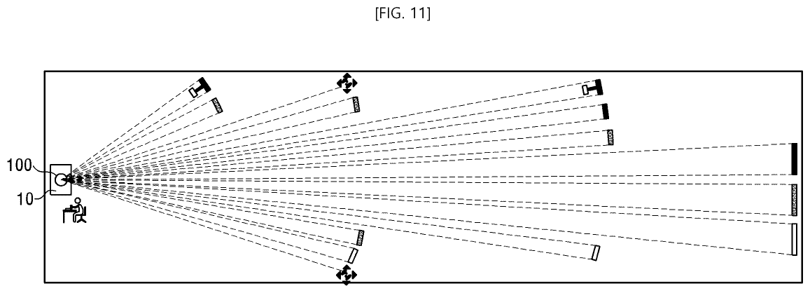

FIG. 11 is an exemplary diagram illustrating an arrangement of the LIDAR device, the calibration device, fiducial marks, and targets for performing the methods illustrated in FIGS. 3, 6, 7, 9, and 10.

As illustrated in FIG. 11, for calibration of the DUT, that is, the LIDAR device 100, the calibration device 10, a measurement space, and at least one target may be provided. Specifically, the calibration device 10 may be connected to the LIDAR device 100, may control the LIDAR device 100 to perform scanning in the measurement space, and may rotate the LIDAR device 100 azimuthally and/or elevationally as needed. In addition, at least one target may be arranged in the measurement space. Details of the targets have been described above. Further, a size of the measurement space may vary depending on a type of the LIDAR device 100 to be calibrated and a type of calibration to be performed.

Although the invention has been described above with reference to embodiments illustrated in the drawings, such embodiments are merely exemplary. It will be understood by those skilled in the art that various modifications and alterations may be made thereto. However, such modifications and alterations should be construed as falling within a technical scope of the present invention. Therefore, a true technical scope of the present invention should be defined by a spirit of the appended claims.

### DESCRIPTION OF REFERENCE NUMERALS

10: Calibration device
11: Azimuthal rotation adjusting unit
12: Elevational rotation adjusting unit
13: Processing unit
14: Memory
100: Light sensing and ranging device or LiDAR device
110: Light emitter
120: Light detector
130: Optical device
140: Encoder
200: Object
S110: Step of recording a single rotation frame
S120: Step of generating an initial GmAPD-based image S130: Step of generating an i-th GmAPD-based image based on an i-th test offset
S140: Step of calculating a pixel-wise structural similarity between the i-th GmAPD-based image and a reference image
S150: Step of calculating a least square cost value of the i-th GmAPD-based image with respect to the reference image
S160: Step of setting a test offset having a minimum least square cost value as a azimuthal-direction offset of the encoder
S210: Step of generating a point cloud using the device under test
S220: Step of performing down-sampling and/or filtering on the generated point cloud and a reference point cloud
S230: Step of setting an initial transformation matrix
S240: Step of deriving an optimal transformation matrix based on a G-ICP algorithm S310: Step of placing at least one fiducial mark S320: Step of scanning the fiducial mark and recording a frame
S330: Step of generating a GmAPD-based image including pixels corresponding to the fiducial mark
S340: Step of identifying three-dimensional coordinate data of the center of the fiducial mark from the GmAPD-based image
S350: Step of performing line fitting between the centers of fiducial marks based on the coordinate data
S360: Step of deriving a laser twist angle based on the line fitting
S410: Step of placing at least one fiducial mark S420: Step of rotating the device under test to an i-th elevational rotation step
S430: Step of recording an i-th frame
S440: Step of generating an i-th GmAPD-based image including pixels corresponding to the fiducial mark
S450: Step of identifying azimuthal coordinate data of the center of the fiducial mark from the i-th GmAPD-based image
S460: Step of calculating an i-th deviation value between the azimuthal coordinate data and reference data
S470: Step of deriving a azimuthal-direction error of the device under test based on the deviation values
S510: Step of placing at least one fiducial mark
S520: Step of rotating the device under test to an i-th azimuthal rotation step
S530: Step of recording an i-th frame
S540: Step of generating an i-th GmAPD-based image including pixels corresponding to the fiducial mark
S550: Step of identifying elevational coordinate data of the center of the fiducial mark from the i-th GmAPD-based image
S560: Step of calculating an i-th deviation value between the elevational coordinate data and reference data
S570: Step of deriving a elevational-direction FOV offset of the device under test based on the deviation values
S610: Step of placing at least one target
S620: Step of recording multiple frames
S630: Step of generating a GmAPD-based image including pixels corresponding to at least a portion of the target
S640: Step of identifying pixels corresponding to the target from the GmAPD-based image
S650: Step of selecting at least some of the identified pixels
S660: Step of calculating an evaluation metric
S670: Step of deriving an evaluation result based on a predetermined criterion
S680: Step of adjusting at least one parameter for each pixel of the device under test based on the evaluation result
S690: Step of ending the calibration process

What is claimed is:

1. A calibration device for LIDAR (Light Detection And Ranging), comprising:
a azimuthal rotation adjusting unit configured to rotate a DUT (Device Under Test) in a azimuthal direction;
a elevational rotation adjusting unit configured to rotate the DUT in a elevational direction; and
a processing unit configured to control operations of the DUT, the azimuthal rotation adjusting unit, and the elevational rotation adjusting unit, and perform calibration for the DUT based on information that the DUT, the azimuthal rotation adjusting unit, and the elevational rotation adjusting unit output.

2. The device of claim 1, wherein the processing unit is configured to:
control the DUT to record a single frame;
control the DUT to generate an initial GmAPD (Geiger-mode Avalanche PhotoDiode)-based image based on the frame;
apply test offsets to the DUT over N-steps, and generate a GmAPD-based image based on each of the test offsets over the N-steps; and
determine a azimuthal direction offset based on the GmAPD-based image.

3. The device of claim 2, wherein the controlling the DUT to record the single frame includes:
controlling the azimuthal rotation adjusting unit to rotate the DUT by a single rotation; and
controlling the DUT to record the single frame during the single rotation.

4. The device of claim 2, wherein the determining the azimuthal direction offset of the DUT based on the GmAPD-based image includes:
calculating a pixel-wise structured similarity cost between each of the GmAPD-based image and a reference image; and
calculating a least square cost value of each of the GmAPD-based image with respect to the reference image based on the structured similarity cost.

5. The device of claim 4, wherein the determining the azimuthal direction offset of the DUT based on the GmAPD-based image further includes:
among the test offsets over the N-steps, determining the test offset which minimizes the least square cost value as the azimuthal direction offset of the DUT.

6. The device of claim 1, wherein the processing unit is configured to:
control the DUT to record a frame, and compute a point cloud based on the frame;
acquire reference data corresponding to the computed point cloud;
perform at least one of down sampling and filtering on each of the point cloud and the reference data;
compute an initial transformation matrix between the point cloud and the reference data, and apply the initial transformation matrix to the DUT; and
compute an optimal transformation matrix for the DUT based on a G-ICP (Generalized Iterative Closest Point) algorithm.

7. The device of claim 6, wherein the transformation matrix, when applied to the DUT, is configured to correct laser skew, azimuthal direction errors, and errors related to elevational direction FOV offset for the DUT.

8. The device of claim 1, wherein the processing unit is configured to:
control the DUT to perform scanning of a plurality of fiducial marks, and record a frame based on the scanning;
control the DUT to generate a GmAPD (Geiger-mode Avalanche PhotoDiode)-based image including pixels which are corresponding to each of the fiducial marks based on the frame;
identify 3-dimensional coordinate data of a center of each of the fiducial marks from the GmAPD-based image;
perform line fitting among the centers of each of the fiducial marks based on the identified 3-dimensional coordinate data; and
compute a laser skew angle of the DUT based on the line fitting.

9. The device of claim 8, wherein the controlling the DUT to perform scanning of a plurality of the fiducial marks, and record the frame based on the scanning includes:
controlling the azimuthal rotation adjusting unit to rotate the DUT in a azimuthal direction by a defined angle; and
controlling the DUT to perform the scanning of the fiducial marks while rotating by the defined angle, and
wherein the fiducial marks are arranged with being spaced apart from the DUT and the calibration device by a same distance.

10. The device of claim 9,
wherein one of the fiducial marks is arranged to be located at one end of a azimuthal direction FOV of the DUT when the DUT starts azimuthal rotation, and
wherein the other of the fiducial marks is arranged to be located at the other end of the azimuthal direction FOV of the DUT when the DUT ends the azimuthal rotation.

11. The device of claim 1, wherein the processing unit is configured to:
control the elevational rotation adjusting unit to rotate the DUT in a elevational direction in N-rotation steps;
control the DUT to perform scanning with respect to at least one fiducial mark at each of the N-rotation steps, and record a frame based on the scanning;
control the DUT to generate a GmAPD (Geiger-mode Avalanche PhotoDiode)-based image based on the frame; and
compute an azimuthal direction error of the DUT based on the GmAPD-based image.

12. The device of claim 11, wherein the GmAPD-based image includes a pixel corresponding to the fiducial mark.

13. The deice of claim 11, wherein the computing the azimuthal direction error of the DUT based on the GmAPD-based image includes:
identifying azimuthal direction coordinate data with respect to a center of the fiducial mark from the GmAPD-based image;
calculating a deviation value between the azimuthal direction coordinate data and reference data for the azimuthal direction coordinate data; and
computing the azimuthal direction error of the DUT based on the deviation value.

14. The device of claim 1, wherein the processing unit is configured to:
control the azimuthal rotation adjusting unit to rotate the DUT in a elevational direction in N-rotation steps;
control the DUT to perform scanning with respect to at least one fiducial mark at each of the N-rotation steps, and record a frame based on the scanning;
control the DUT to generate a GmAPD (Geiger-mode Avalanche PhotoDiode)-based image based on the frame; and
compute an elevational direction FOV offset of the DUT based on the GmAPD-based image.

15. The device of claim 14, wherein the GmAPD-based image includes a pixel corresponding to the fiducial mark.

16. The device of claim 14, wherein the computing the elevational direction FOV offset of the DUT based on the GmAPD-based image includes:
identifying elevational direction coordinate data with respect to a center of the fiducial mark from the GmAPD-based image;
calculating a deviation value between the elevational direction coordinate data and reference data for the elevational direction coordinate data; and
computing an azimuthal direction FOV offset of the DUT based on the deviation value.

17. The device of claim 1, wherein the processing unit is configured to:
control the DUT to perform scanning of at least one target, and record a plurality of frames based on the scanning;
control the DUT to generate a GmAPD (Geiger-mode Avalanche PhotoDiode)-based image based on the frame, GmAPD-based image including a pixel corresponding to the target;
identify pixels of the GmAPD-based image corresponding to the target on the GmAPD-based image;
select at least some of the identified pixels;
compute an evaluation value for the selected pixels;
compute an evaluation result for the evaluation value based on a defined criterion; and
adjust parameters for each of a plurality of the pixels included in the DUT based on the evaluation result.

18. The device of claim 17, wherein, when the at least one target comprises a plurality of the targets, the plurality of the targets are configured such that at least one of reflectivity and distance is different from one another.

19. The device of claim 17, wherein the identifying the pixels of the GmAPD-based image corresponding to the target on the GmAPD-based image includes:
identifying azimuthal direction coordinate data and elevational direction coordinate data included in each of the pixels of the GmAPD-based image corresponding to the target; and
identifying a minimum value and a maximum value with respect to each of the azimuthal direction coordinate data and the elevational direction coordinate data, and
wherein the selecting the at least some of the identified pixels is performed based on the minimum value and the maximum value with respect to each of the azimuthal direction coordinate data and the elevational direction coordinate data.

20. The device of claim 17, wherein the evaluation value is at least one selected from the group consisting of a true positive rate and a false positive rate for distance information calculated by the DUT, an average and a standard deviation of distance bias, and an average of signal intensity, and
wherein the evaluation result is output depending on whether the evaluation value falls within a defined numerical range.
